(19) United States
(12) Patent Application Publication
(10) Pub. No.: US 2008/0020082 A1
(43) Pub. Date: Jan. 24, 2008

(54) PRESS FOR PRODUCING PRESSED PARTS FROM POWDERED MATERIAL

(76) Inventors: Martin Plucinski, Asendorf (DE); Thomas Pannewitz, Klein Pampau (DE); Udo Baltruschat, Pinneberg (DE); Carsten Jordt, Geesthacht (DE); Andreas Groth, Schwarzenbek (DE); Andreas Teetzen, Schwarzenbek (DE); Harald Romer, Reinbek (DE); Jan Naeve, Schattin (DE); Stephan Mallon, Kollow (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/736,930

(22) Filed: Apr. 18, 2007

(30) Foreign Application Priority Data
May 2, 2006 (DE) 10 2006 020 213.9

(51) Int. Cl. B30B 11/02

(52) U.S. Cl. 425/135; 100/3; 425/78

(57) ABSTRACT

Press for producing pressed parts from powdered material with a die which may be clamped to a die table arranged in a press frame, in which a mould cavity is configured with a recess, and at least one upper and lower punch which cooperate with the mould cavity, the mould cavity being defined by at least one slider, transverse press punch or a movable part of the die, which may be displaced transversely to the vertical axis of the upper and lower punch (main pressing axis), and adjusting drives for the upper and lower punch and the slider and/or the displaceable die part attached in the press frame, characterised in that a sensor measures actual conditions of the adjusting drive for the slider, transverse press punch or the displaceable die part, the actual conditions being compared in a control device with a desired value and the control device actuating the adjusting drive for a slider, the transverse press punch or the displaceable die part via the energy supply to the adjusting drive according to the difference between the actual and desired condition.

### CROSS-REFERENCE TO RELATED APPLICATIONS

Not applicable.

### STATEMENT REGARDING FEDERALLY SPONSORED RESEARCH

Not applicable

### BACKGROUND OF THE INVENTION

Such presses serve, for example, to produce pressed parts from metal powder for the subsequent sintering process, for example for the production of tools, such as cutting tools or the like. The powdered material is filled into the mould cavity of a die by means of a suitable filling device. The die is fastened onto a die plate or a die table and which, in turn, is arranged in a press frame. In the press frame, adjusting drives for at least one upper punch and at least one lower punch are also arranged which cooperate with the mould cavity and/or the powder therein. The axes of the adjusting drives are coaxial and vertical. A conventional drive provides, for example, hydraulic cylinders.

In order to avoid subsequent finishing or at least to keep subsequent finishing to as low a level as possible, it is necessary to produce the pressed part as dimensionally accurately as possible. To this end, it is necessary that the material is compressed in a reproducible manner as the subsequent contraction process is dependent on the density of the material. Reproducible dimensions of the pressed part are also desired as the punches move towards a predetermined final position inside the mould cavity. Mole specifically, it is conceivable to predetermine this final position by end stops, but such stops are conventionally not used due to the speed of production and/or protection of the tools. Instead, it is known to actuate the punches of such presses via a suitable control or regulating device. Thus it is already known to associate a path measuring system with the press punches and to control the press punches according to the measured positions as far as a final position, and possibly also according to the time taken. In the latter case, the speed of the punch is a criterion for the production of the pressed part.

If moved into a position, a predetermined geometry of the pressed part is able to be maintained. Different filling amounts, however, might have the result that the sintered final product does not have reproducible dimensions. It is also already known, therefore, to finish the pressing process when a predetermined moulding pressure has been reached. In this connection, therefore, the final positions of the press punch may vary widely. Finally, it is also known to provide a path force curve along which the press punch is moved during the compression process. A constant control takes place during the pressing process, specific press forces being possibly associated with specific positions of the press punch during its press path and/or an adjustment taking place in such a manner that the desired curve is achieved. To this end, it is also necessary to measure the press force which is exerted on the powdered material.

In this connection, it is known to measure the press force directly via pressure measurement cells between the hydraulic cylinders and the punches. It is, however, also known to measure the press force indirectly via a pressure sensor, which measures the pressure in a hydraulic cylinder.

A pressed part has the tendency, after the completion of the compression phase, to expand to a certain extent. In this connection, there is the danger that tears or the like result in the pressed part, when such an expansion takes place too rapidly. It is, therefore, already known to allow a specific applied load to act on the pressed part after pressing, and to remove this applied load only after some time. It is finally also known to predetermine the level of the applied load depending on the material, as well as the reduction of the applied load by means of the control device, which is in any case present.

The removal of a pressed part from the mould cavity in the die is carried out typically by a relative movement of the lower punch and the die. With the so-called ejection method, the die is stationary and the lower punch moves the pressed part level with the upper edge of the die. With the withdrawal method, however, the lower punch is stationary and the die is displaced downwards by the desired amount. A removal, however, causes problems, if the pressed part has recesses. It is, however, already known to divide a die for the production of pressed parts from powdered material and to move the die parts away from one another to remove the pressed part. It is already further known, for the production of recesses, bores or the like, to insert sliders which are displaceably mounted in the die along an axis which is transverse to the main pressing axis. The slider is located in the mould cavity during the filling and removed before the pressed part is ejected Finally, it is also known to guide a press punch along an axis obliquely to the main pressing axis in the die, in order to exert a lateral moulding pressure. In these cases, the displaceable parts must also have an adjusting drive which is generally formed by a hydraulic cylinder. The final position of such a movable part in the mould cavity is formed by an end stop.

The object of the invention is to provide a press for producing pressed parts from powdered material, by means of which pressed parts may be made with recesses in a reproducible manner with high accuracy without damaging the internal structure of the pressed parts.

### BRIEF SUMMARY OF THE INVENTION

With the press according to the invention, a sensor is provided which measures the actual conditions of the adjusting drive for the slider, the transverse punch or a displaceable part of the die. The actual conditions are, for example, the positions of the transverse adjusting drive and or the part driven therewith, and the force which the adjusting drive applies etc. The measurement of one or more such actual values not only occurs during the pressing process but also during the unloading of the pressed part. A control device compares one or more actual conditions with a desired value and/or a desired value curve and the adjusting drive is accordingly displaced according to the difference between the actual value and the desired value.

By means of the invention, therefore, the transversely movable part (slider, transverse punch, die part) may be displaced in a controlled manner and namely both in the compression phase and in the decompression phase. By means of the invention, the transversely movable part may be accurately moved into a desired position which may also be different and which may not be implemented by end stops.

By means of the invention, the pressed parts which comprise an undercut and/or a recess and which may not be removed in the conventional manner from the die, may be produced in a reproducible manner and equally well as in the case of simply formed pressed parts.

According to an embodiment of the invention, a hydraulic, pneumatic, electrical or electromechanical adjusting drive is provided.

In a further embodiment of the invention, a path measuring system is associated with the adjusting drive and the control device stops the adjusting drive if a predetermined position of the slider, the transverse punch or the die part has been reached, or the adjusting drive displaces the driven part according to a predetermined path time curve.

The path measuring system may be operated optically, inductively or magnetostrictively or by means of a rule on which a vernier caliper gauge actuated by the adjusting drive is guided.

According to a further embodiment of the invention, a force measuring system may be associated with the adjusting drive and the control device displaces the adjusting drive according to predetermined force values or according to a predetermined force time curve or force path curve. For measuring the force applied to the pressed material, a load cell may be provided or a pressure sensor.

The adjusting drive for the transversely movable part is, according to a further embodiment of the invention, preferably arranged on the die table. Finally, according to an embodiment of the invention, it is provided that the mould cavity has no end stop for the transversely displaceable part. As a result, the cost of the die is reduced and the risk eliminated of damage occurring to the adjustable part and tool.

### BRIEF DESCRIPTION OF THE SEVERAL VIEWS OF THE DRAWINGS

Embodiments of the invention are described in more detail hereinafter with reference to drawings, in which:

FIG. 1 shows a press according to the invention in a perspective view.

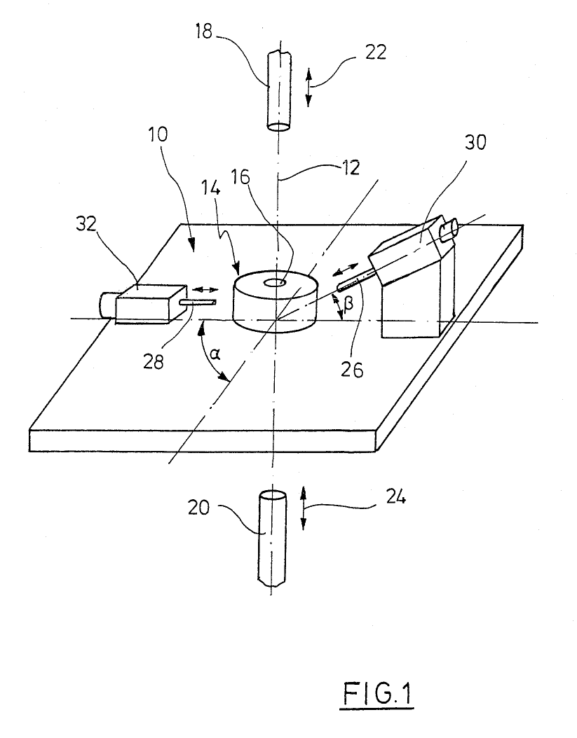

FIG. 2 shows a block diagram for the control of an adjusting drive of the press according to FIG. 1.

FIG. 3 shows a further embodiment of a press according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

A die table 10, which may also be denoted as a die plate, is arranged in a flame of a press, not shown, for the production of powdered goods. The die table 10 may be arranged in a stationary manner in the press frame (ejection operation) or may in turn be displaced vertically along an axis 12 by hydraulic cylinders, not shown here (withdrawal method). A die 14 is fastened to the die table 10 with a mould cavity 16. An upper punch 18 and a lower punch 20 cooperate with the mould cavity. The upper and lower punch 18, 20 may be displaced by a hydraulic drive, not shown, along the axis 12, as indicated by the double arrow 22 and/or 24. When filling the mould cavity 16 with a pressing powder by means of a filling device, not shown, the lower punch 20 is located to a certain extent in the mould cavity 16 and thereby predetermines the filling volume. The upper punch 18 is located at a distance vertically above the die 14. During the compression phase, the hydraulic drives drive the punches 18, 20 and compress the pressing material in the mould cavity 16 to form a pressed part of predetermined dimensions and density.

The mould cavity 16, which may not be seen into, contains a recess which makes it necessary for an additional press punch to be effective in this region. Such a press punch is shown at 26. Moreover, a bore is intended to be produced in the pressed part. To this end, a rod-shaped moulding tool 28 producing the bore is provided in the form of a slider. Both tools are actuated by means of a hydraulic adjusting drive 30 and/or 32. The axis of the transverse press punch 26 is at an angle β to the horizontal which is formed by the upper face of the die table 10. The slider 28 is parallel to the upper face of the die table 10 and radial relative to the axis 12. The die 14 comprises corresponding apertures, not shown here, through which the moulding tools 26, 28 may penetrate into the mould cavity 16.

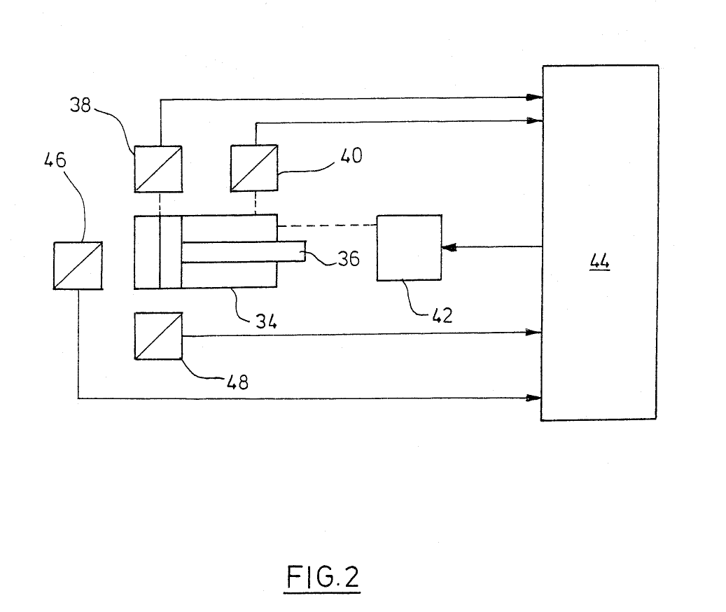

The hydraulic drives 30, 32 are operated in a controlled manner. This is shown in FIG. 2. In FIG. 2 only the control of the drive 30 is shown. The adjusting drive 30 is implemented in FIG. 2 by a hydraulic cylinder 34 with a piston rod 36 which is coupled to the transverse press punch 26. Pressure sensors 38, 40 measure the pressure in the piston space and piston rod space of the hydraulic cylinder 34 which may be coupled to a hydraulic pressure source, not shown here, via a control valve 42. The activation of the control valve is carried out by means of a computer 44 to which the measuring signals of the pressure sensors 38, 40 are also sent.

A force sensor 46 measures the pressing force produced by the cylinder 34 onto the transverse press punch 26 and sends its measuring signals to the computer 44. A position sensor 48 measures the position of the hydraulic cylinder 34 and/or the piston and/or the piston rod 36 and also sends its measuring signals to the control computer.

Different desired values and/or desired curves may be stored in the control computer 44. Thus, for example, the end position of the drive 34 may be predetermined. If it is reached, which is established by the position sensor 48, a further displacement of the hydraulic cylinder 34 is stopped. A path time curve may also be stored in the control computer, the path which the transverse press punch 26 covers by means of the hydraulic cylinder 34 being measured, in turn, by means of the position sensor 48. In this connection, the computer 44 ensures that the predetermined path is followed within a predetermined time. A control unit adjusts deviations of the measured actual conditions from the desired condition.

Furthermore, a predetermined maximum force may be stored in the computer which is measured by means of the force sensor. The force sensor may, for example, be a load cell which, between the piston rod 36 and the transverse punch 26, may also be indirectly formed by, for example, the pressure sensor 38. If the transverse press punch reaches a predetermined maximum force during the pressing process, the displacement is terminated. In the computer 44, a path force curve may be additionally or alternatively stored along which the transverse press punch 26 carries out its pressing process.

As in the compression phase, after completion of this phase, the transverse punch 26 may be specifically removed from the mould cavity 16, for example by a reduction of the pressing force and slow withdrawal according to predetermined parameters. Such a desired curve and/or such desired parameters may also be stored in the computer 44 so that after the pressing process, a specific unloading of the pressed part is possible by the transverse punch 26.

It is understood that the slider 28 may be actuated by a similar control device as shown in FIG. 2. It is further understood that the die 14 may be a so-called split die, of which at least one part is removed from the stationary part in a direction which is transverse to the axis 12, in order to facilitate, and/or simply to allow, the removal of the pressed part from the mould. In this connection, the removal is desired in particular in a controlled manner in order to unload the pressed part in a specific manner, so that tears or the like are avoided after the compression phase. The actuation of the adjustable die part may also be undertaken by one of the disclosed drives 30 and/or 32 with a control device according to FIG. 2.

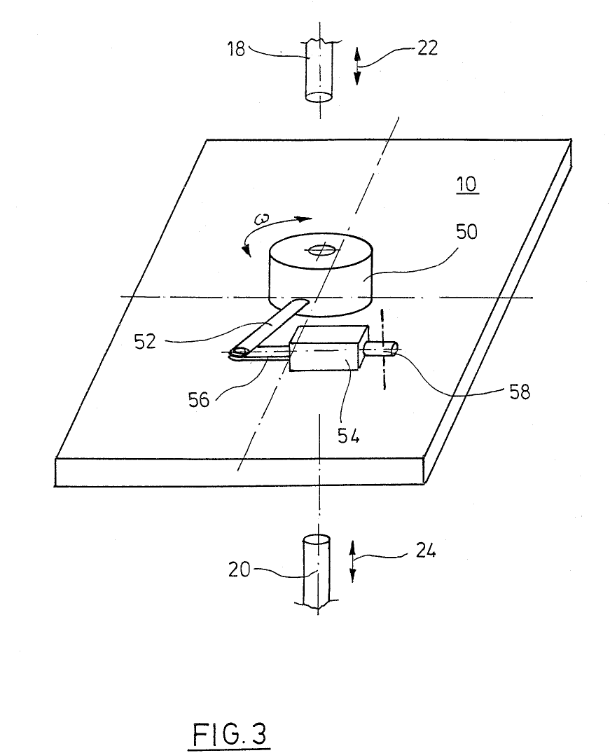

In FIG. 3, a die 50 is rotatably mounted on a die table 10. The angle of rotation is indicated by ω. A lever 52 is attached to the die 50 which cooperates with a piston rod of an adjusting cylinder 54. The adjusting cylinder 54 is articulated to the die plate 10 at 58. By means of the adjusting cylinder 54, therefore, the die 50 may be rotated during the pressing process. The upper punch 18 and the lower punch 20 are, for example, drilled for producing obliquely toothed and/or drilled parts, such as for example drill tips. The drilled upper and lower punch 18, 20 move vertically in the die 50, whilst said die rotates. For removing from the mould, the rotary movement of the die is reversed.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims) In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What we claim is:

1. Press for producing pressed parts from powdered material with a die which may be clamped to a die table arranged in a press flame, in which a mould cavity is configured with a recess, and at least one upper and lower punch which cooperate with the mould cavity, the mould cavity being defined by at least one slider, transverse press punch or a movable part of the die, which may be displaced transversely to the vertical axis of the upper and lower punch (main pressing axis), and adjusting drives for the upper and lower punch and the slider and/or the displaceable die part, attached in the press flame, characterised in that a sensor measures actual conditions of the adjusting drive for the slider, transverse press punch or the displaceable die part, the actual conditions being compared in a control device with a desired value and the control device actuating the adjusting drive for a slider, the transverse press punch or the displaceable die part via the energy supply to the adjusting drive according to the difference between the actual and desired condition.

2. Press according to claim 1, characterised in that a hydraulic, pneumatic, electrical or electromechanical adjusting drive is provided.

3. Press according to claim 1, characterised in that a path measuring system is associated with the adjusting drive and the control device stops the adjusting drive if a predetermined position of the slider, the transverse punch or displaceable die part has been reached or the adjusting drive displaces the slider, transverse punch or displaceable part of the die according to a predetermined path time curve.

4. Press according to claim 3, characterised in that an optical, inductive or magnetostrictive path measuring system is provided.

5. Press according to claim 1, characterised in that a force measuring system (46) is associated with the adjusting drive and the control device displaces the adjusting drive (34) according to predetermined force values or according to a predetermined force time curve.

6. Press according to claim 5, characterised in that a load cell or a pressure sensor is associated with the adjusting drive (34).

7. Press according to claim 3, characterised in that control unit displaces the adjusting drive according to a predetermined force position curve.

8. Press according to claim 1, characterised in that the adjusting drive for the slider, the transverse punch or the movable die part is arranged on the die table (10).

9. Press according to claim 1, characterised in that the adjusting drive for the slider, the transverse punch or the displaceable die part is fastened in the pressing space of the press frame.

10. Press according to claim 1, characterised in that the adjusting drive (34) optionally actuates a press punch (26).

11. Press according to claim 1, characterised in that no end stop is associated with the die or the adjusting drive for the slider, transverse punch or the displaceable die part.

12. Press according to claim 1, characterised in that the die (50) is rotatably mounted on a die table (10) and an adjusting cylinder (54) is arranged on the die table which is in rotary drive connection with the die (50) via a gear mechanism (56, 52).
